(19) United States
(12) Patent Application Publication
(10) Pub. No.: US 2025/0269831 A1
(43) Pub. Date: Aug. 28, 2025

(54) BRAKE SYSTEM AND METHOD FOR OPERATING A BRAKE SYSTEM

(71) Applicant: Continental Automotive Technologies GmbH, Hannover (DE)

(72) Inventors: Andreas Kohl, Mainz (DE); Rüdiger Puff, Hünstetten-Wallbach (DE); Martin Baechle, Kelkheim (DE)

(73) Assignee: Continental Automotive Technologies GmbH, Hannover (DE)

(21) Appl. No.: 18/856,825

(22) PCT Filed: Apr. 4, 2023
(86) PCT No.: PCT/DE2023/200070

§ 371 Date: Oct. 14, 2024

(30) Foreign Application Priority Data
Apr. 14, 2022 (DE) 10 2022 203 770.7

(51) Int. Cl. B60T 13/66; B60T 7/04; B60T 13/74

(52) U.S. Cl. CPC B60T 13/662; B60T 7/042; B60T 13/741

(57) ABSTRACT

A brake system includes a dry brake pedal with a pedal sensor for detecting the driver input. The brake system also includes four electrically controllable wheel brake modules, each including an electrically controllable wheel brake.

A first axle controller is assigned two wheel brake modules and a second axle controller is assigned two further wheel brake modules. Each of the axle controllers is connected to the brake pedal on a signal input side Each of the axle controllers includes two control units, which each control one wheel brake.

### CROSS-REFERENCE TO RELATED APPLICATIONS

This application is a national stage application, filed under 35 U.S.C. § 371, of International Patent Application No. PCT/DE2023/200070, filed on Jul. 1, 2018, which is incorporated by reference herein in its entirety.

### TECHNICAL FIELD

The technical field relates to a brake system having a dry brake pedal with a pedal sensor for detecting the driver input and four electrically controllable wheel brake modules.

### BACKGROUND

In motor vehicle technology, “brake-by-wire” brake installations are being used ever more widely. Brake systems of this kind often comprise a brake pedal which is designed as an electronic pedal. The brake pedal detects a driver braking input by means of a pedal travel sensor or pedal angle sensor and, from this, generates a driver braking input signal. In these brake systems, the driver can be decoupled from direct access to the brakes. The detected braking input leads to the determination of a setpoint braking torque, from which the setpoint brake pressure for the brakes is then obtained. For this purpose, the driver braking input signal is transmitted to a central control unit, which performs the electric control of the wheel brakes. Here, the wheel brakes can be designed as electromechanical (dry) brakes.

The disadvantage with such an architecture of the brake system is that, if the central control unit fails, it is immediately necessary to switch to a fallback level and the brake boosting cannot be maintained, as a result of which the controllability of the vehicle is greatly reduced and the safety of the vehicle occupants is at risk.

It is therefore desirable to provide an operating system with improved safety. It is furthermore sought to specify a corresponding operating method.

### SUMMARY

In respect of the brake system, two axle controllers are provided, wherein a first axle controller is assigned two wheel brake modules and a second axle controller is assigned two further wheel brake modules, wherein each of the two axle controllers is connected to the brake pedal on a signal input side, and wherein each of the two axle controllers comprises at least one control unit or else two control units, which each control one wheel brake.

In the event of a malfunction of the control unit, the controllability of the vehicle during a braking process should continue to be maintained as far as possible. In the event of a fault, brake boosting should be maintained. In contrast, the control functions can be switched off in the case of a first fault. Ultimately, the design of a brake system should ensure that no first fault in the sensor/actuator disables the brake boosting.

According to one embodiment, provision can be made for each of the two axle controllers to include at least one control unit, which in each case controls at least one wheel brake. In certain embodiments, which will be explored in greater depth below, it is also possible for one control unit to control two wheel brakes, e.g., the two wheels assigned to one axle. An axle controller can be understood to mean that one or two control units are brought together, i.e., centrally, in a common module or housing, and are not assigned in a decentralized manner to individual wheel brakes.

In the case of just one control unit in an axle controller, this control unit can be designed to control each of the two wheel brakes of the assigned axle. In respect of costs, this thus represents a particularly advantageous arrangement, even though there is virtually no redundancy here since, if the control unit fails, it may no longer be possible to control both wheel brakes on an axle under certain circumstances in this case. It is for this reason that this embodiment is suitable primarily for the rear axle.

It is therefore advantageous if at least one axle controller, such as the axle controller assigned to the front axle, includes at least two control units, wherein each control unit can control at least one wheel brake. If one control unit in this axle controller fails, there is thus at least one other control unit available which can control the other wheel, ensuring that it is still possible to brake at least one wheel if one control unit fails.

In another advantageous embodiment, which will be explored in greater depth below, it is envisaged that the axle controller is designed to ensure that, if one control unit in the axle controller fails, the other control unit in the same axle controller can take over the control of the wheel brakes of the wheels on the axle.

It is thereby possible, for example, to make available a brake system in which one axle controller, such as the axle controller assigned to the rear axle, includes just one control unit and another axle controller, such as the axle controller assigned to the front axle, having two control units. This arrangement thus provides a brake system comprising three control units and offers a high degree of redundancy, especially if one control unit fails, combined at the same time with more moderate costs in comparison with solutions that have two control units per axle controller, i.e. a total of four control units.

As has now been recognized, the abovementioned requirements can be met if, instead of one central control unit for all the brakes, two axle controllers are provided, each comprising two control units which receive the driver braking input signal directly from the brake pedal. To reduce the unsprung masses, only those components which are actually necessary should be mounted on the wheel, these being in each case the motor position sensor and the wheel speed sensor. The control electronics are integrated into the axle controller and are therefore largely protected from shocks.

Here, the brake pedal is designed to generate from the measured driver braking input a corresponding signal, which is transmitted to the two axle controllers.

The respective wheel brake module advantageously includes at least one brake actuator and/or one sensor and/or one valve and/or at least one warning lamp, wherein the respective axle controller is designed to ensure that, if one control unit in the axle controller fails, the other control unit in the same axle controller carries out the control of the brake actuator and/or of the respective valve and/or the evaluation of the respective sensor signal and/or the operation of the respective warning lamp. In the case of a sensor, this means that the respective sensor signal is substituted. In the case of a warning lamp, this means that the warning lamp on the side with the failed control unit is switched on and off by the still functioning control unit in synchronism with the warning lamp on the side of the functioning control unit. In the case of a valve, this means that the valve is controlled in synchronism with the valve on the intact side. In the case of an actuator, this means, in particular, that the actuator is controlled in synchronism with the actuator on the intact side. This applies especially to the control of an electric motor. In each case, the wheel brake module comprises, in particular, a wheel speed sensor and/or a motor position sensor.

In one embodiment, the two control units in an axle controller are connected to one another in such a way that, if one control unit in an axle controller fails, the other control unit in this axle controller takes over the control of the wheel brake in the wheel brake module which is assigned to the failed control unit. If a control unit for one wheel brake fails, this enables both wheel brakes that are assigned to the respective axle controller to be controlled by the still functioning control unit. For this purpose, a bidirectional, advantageously redundant, signal line is preferably provided in each of the two axle controllers between the two control units of the same axle controller.

Even if the signal connection between the brake pedal and one axle controller fails, control of the wheel brakes can continue, and therefore the brake boosting is not dropped and is maintained. The two axle controllers may be of identical design, thus reducing production costs.

The respective control unit may include a control connection to a B6 bridge for connection to the other control unit. In this way, it is possible, in particular, to connect the three phases of an electric motor of a wheel brake to the other control unit. To ensure electronic redundancy, the B6 bridge/GDU on one side is used, if a B6 bridge/GDU on the other side fails, to synchronously control both motors of the wheel brakes, which in this case are designed as electromechanical brakes. In this case, it is then only possible to operate the motors synchronously, but this is sufficient for brake boosting. A prerequisite here is that both motors have the same alignment angle, this being made possible by synchronized driving at the start of motor control.

A cross switch is advantageously arranged in the respective control connection. Fuses may be arranged in the respective connection between a B6 bridge and a wheel brake. The B6 bridge on the side of the functioning control unit is used to burn through the fuses, which may be designed as ETFs (electric thermal fuses), in the control connection of the non-functioning control unit. A cross switch is therefore required from each side behind the ETFs of the other side.

In each case, at least one redundant bidirectional signal line may lead from the first axle controller to the second axle controller, wherein the two axle controllers are designed to enable each of the two control units of the first axle controller to take over the functionality of each of the two control units in the second axle controller and vice versa. That is to say that each of the two control units of the second axle controller or axle control unit is designed to take over control of a wheel brake on the other axle controller.

In one embodiment, at least one of the signal lines is routed via the brake pedal. Here, the brake pedal acts as a hub or router. The lines for transmitting the driver braking input and the lines for routing between the axle controllers can be the same, or additional routing lines are provided. The corresponding signal line may be designed as a CAN line.

According to one embodiment, the brake pedal can be connected via a first signal line to the first axle controller and via a second signal line, which is preferably separated from the first signal line, to the second axle controller.

The respective wheel brake may be designed as an electromechanical brake, i.e. all the wheel brakes are designed as electromechanical brakes (EMB).

It is advantageous if a pawl is integrated into at least two wheel modules. In this case, the pawl is preferably used to lock the wheel module when a certain brake application force is applied, thus enabling the wheel module with the pawl to act as a substitute for an integrated parking brake (IPB). In particular, it is possible here for the pawl to be designed to lock the drive of the wheel module. As a particular preference, the wheel modules with a pawl should be assigned to the rear axle of the vehicle.

In one embodiment, the respective axle controller has just one processor with at least two cores. In this case, the respective control unit is designed as one core of this processor. For example, the control unit for the left-hand wheel is designed as Core0 and the control unit for the right-hand wheel is designed as Core1 in the axle controller. On the software side, Core0 executes the software which comprises the control functions for the left-hand wheel, and, on the software side, Core1 executes the software which comprises the control functions for the right-hand wheel. In this case, the software in both cores is designed in such a way that, if one of the two cores fails, the other core can take over the control functions of the failed core. Further cost optimization is made possible by this design. The control units of an axle controller are thus designed as two cores of the same processor.

In respect to the method, if one control unit malfunctions or fails, another control unit takes over the control of the failed or malfunctioning control unit via a signal line.

The advantages include, in particular, in that only a small number of components is required as unsprung masses, resulting in a smaller installation space on the wheel. The axle control unit is divided internally into two independent wheel control units with separate power supplies, eliminating the need for a central module since there is a redundant and identically constructed type in each axle control unit, thereby saving the costs for the architecture of the central control unit.

Only the design of an axle controller architecture is required, and this is the same for both axles. In this way, the number of components on unsprung masses can be reduced to a minimum. The proposed brake system is less expensive and more durable than current architectures for a dry brake and comprises fewer components on unsprung masses.

Since all the components in one control unit are redundantly present, based on two wheels, it is possible in the event of a fault for one side to take over the control of the other side, and it is therefore possible to dispense completely with the redundant components for one wheel. Brake boosting can therefore be maintained with any first fault.

A redundant connection for driver input detection is implemented directly via an electronic pedal and via an internal connection from one control unit to the other, thereby increasing safety. An increase in safety is likewise obtained in the variant with communication from one wheel module to the other via an electronic pedal.

An electronic parking brake functionality for all four wheels can be achieved by a respective pawl in each of the wheel modules.

Since two control units are located in a common housing, the redundancy can be simplified: all the components are redundantly present but are used simultaneously for two motor control systems. A simple MCU/PCU failure would result in a functional degradation, but brake boosting is maintained in the case of any individual fault in the actuators/sensors. On the fallback level, the remaining MCU/PCU then takes over the control of both sides.

To ensure the electronic redundancy, the B6 bridge/GDU on one side can be used, in the event of a fault in a B6 bridge/GDU on the other side, to synchronously control both motors and, although it is therefore then only possible to operate the motors in synchronism, this is sufficient for brake boosting. A prerequisite for this is that both motors have the same alignment angle. A synchronizing operation at the start of motor control is then required.

The internal communication also enables a diagonal circuit split:
if one actuator fails, the corresponding diagonal actuator can be shut down
and it is therefore also possible to manage “diagonal vehicles”. The power supply can also be designed in such a way that a control unit for the right-hand side of the vehicle in one of the two axle controllers and a control unit for the left-hand side of the vehicle in the other axle controller are supplied with a first supply voltage, and the other two control units are correspondingly supplied with a second supply voltage. Of course, a black/white circuit configuration of the wheel modules is also conceivable.

### BRIEF DESCRIPTION OF THE DRAWINGS

Exemplary embodiments will be described in greater detail with reference to drawings, in which, in a highly schematic view:

FIG. 1 shows a brake system in a first exemplary embodiment;

FIG. 2 shows a brake system in a second exemplary embodiment; and

FIG. 3 shows a circuit arrangement of an axle controller of a brake system.

### DETAILED DESCRIPTION

In all of the figures, identical parts are provided with the same reference signs.

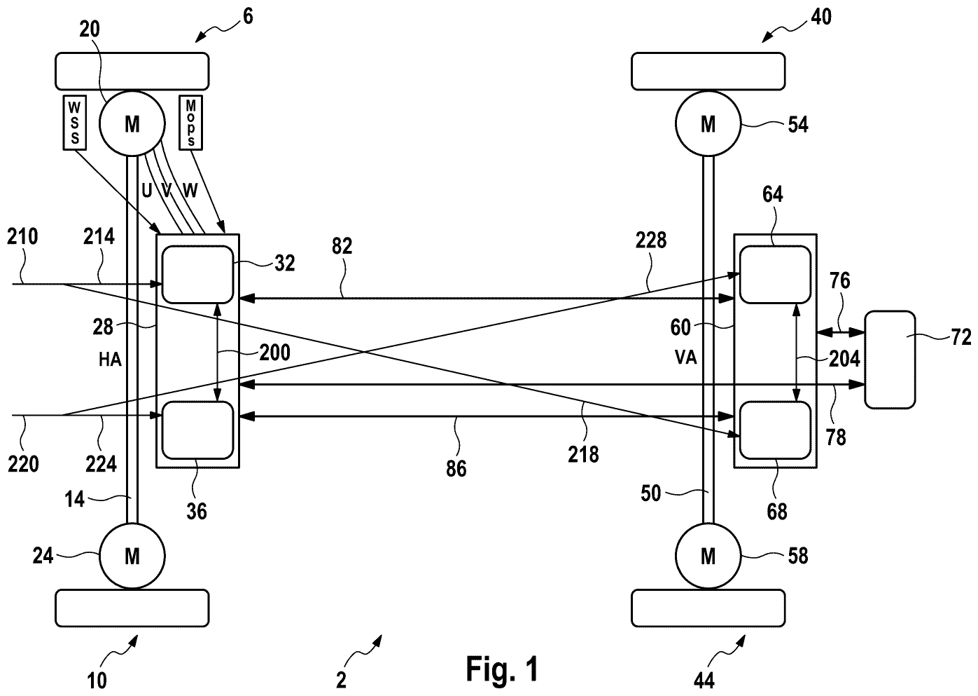

A brake system 2 illustrated in FIG. 1 has two wheel brake modules 6, 10, which are assigned to a rear wheel axle 14 and each have a first and a second rear wheel brake 20, 24 (the motors being illustrated in each case). The brake system 2 has an axle controller 28 or axle control unit, which has a control unit 32 for controlling the first rear wheel brake 20 (e.g. for a left-hand vehicle wheel) and a second control unit 36 for controlling the second rear wheel brake 24 (e.g. for a right-hand vehicle wheel).

The brake system 2 furthermore has two wheel brake modules 40, 44, which are assigned to a front wheel axle 50 and each have a first and second front wheel brake 54, 58. The brake system 2 has an axle controller 60, which has a control unit 64 for controlling the first front wheel brake 54 (e.g. for a left-hand vehicle wheel) and a second control unit 68 for controlling the second front wheel brake 58 (e.g. for a right-hand vehicle wheel).

In the present case, the wheel brakes 20, 24, 54, 58 are designed as electromechanical brakes and each have a motor, which presses a braking element against a brake disk as required. The respective axle control unit or respective axle controller 28, 60 is thus divided internally into two independent wheel control units, which preferably have a separate power supply KI30 for each circuit board. The two control units 32, 36 and 64, 68 are galvanically separated from one another and are arranged in a common housing.

Even though the following considerations relate essentially to embodiments that have two control units 32, 36, 64, 68 per axle controller 28, 60, it should be understood that embodiments with just one control unit, as explained above, are also conceivable and possible, as are, in particular, embodiments that have one control unit 32 on axle controller 28, e.g. the rear axle, and two control units 64, 68 on axle controller 60, e.g. the front axle. Accordingly, the brake system 2 can also have, for example, three control units 32, 36, 64, 68, distributed between two axle controllers 28, 60.

The wheel brake modules 6, 10, 40, 44 belong to the unsprung masses of the vehicle, while the axle controllers 28, 60 belong to the sprung masses.

In other embodiments, the wheel brakes 20, 24, 54, 58 may also be of different design, e.g., electrohydraulic design, if they can be controlled electrically with a control unit.

The brake system 2 is designed as a dry by-wire brake system and has a (dry) brake pedal 72 (electronic pedal in the present case), which comprises a sensor for detecting the driver braking input, which is preferably designed as a pedal travel sensor or pedal angle sensor, and a unit for generating a braking input signal.

The brake pedal 72 is in each case connected to the two axle controllers 28, 60 by a braking input signal line 76, 78. In the present case, the two braking input signal lines 76, 78 are of bidirectional design. The respective axle controller 28, 60 controls its corresponding control units 20, 24 and 64, 68, respectively, in accordance with the braking input transmitted from the brake pedal 72.

The brake system 2 has a bidirectional signal line 82, 86 (illustrated by two arrows), which connects axle controller 28 to axle controller 60 in terms of signal transmission and consequently allows redundant communication between the axle controllers 28 and 60. In the event of failure of one of the braking input signal lines 76, 78, this enables the control unit 32, 64 of the axle controller 28, 60 which is still connected to the brake pedal 72 on the signal input side to transmit the signal to the control unit 64, 32 of the other axle controller 28, 60.

By virtue of the direct transmission of the braking input from the brake pedal 72 via two braking input signal lines 76, 78, it is possible to dispense with a central control unit.

A redundant and bidirectional signal line 200 is provided between the control units 32 and 36 of the axle controller 28. A redundant and bidirectional signal line 204 is provided between the control units 64 and 68 of the axle controller 60. In connection with the signal lines 82, 86, provision is also made for the signals of one control unit 32, 36, 64, 68 or wheel module 6, 10, 40, 44 from one of the two axle controllers 28, 60 to be transmitted to one control unit 32, 36, 64, 68 of the other control unit 36, 32, 86, 64. In this way, for example, the signals of wheel module 6, e.g., sensor signals, can be transmitted to the control unit 68 of the other axle controller 60 via line 200 and line 82. Via this signal path, control unit 68 can, in particular, also take over the control of components of wheel module 6.

The two wheel brake modules 6, 10 each have a pawl, or the pawl is integrated into the wheel brake module, thereby implementing the functionality of an electronic parking brake. In other embodiments, all the wheel brake modules 6, 10, 40, 44 can have a pawl.

The brake pedal 72 may include two sensors, which are advantageously based on two different measurement principles. Thus, for example, a force sensor, which measures how forcefully the driver presses the pedal, and a travel sensor, which measures how far the driver depresses the pedal, are used. With these different redundant sensors, the fault patterns are different, and therefore a jammed pedal, for example, can be detected from the fact that force is exerted on the pedal without the latter moving. The two signals from these two sensors are preferably sent from the brake pedal 72 to the respective axle controller 28, 60, or a combined signal is sent.

As shown in FIG. 1, two separate signal lines 76, 78 can be provided for this purpose, which can transmit signals to the respective axle controller 28, 60 from the brake pedal 72 independently of one another. Accordingly, the signal lines 76, 78 can be structurally separated from one another.

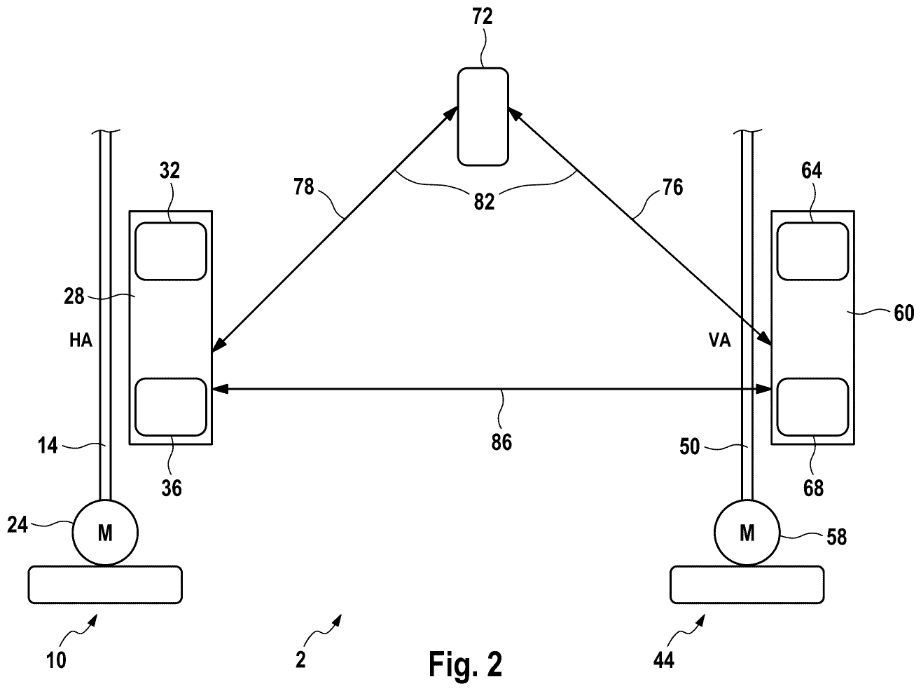

FIG. 2 illustrates a brake system 2 in a second exemplary embodiment. In respect of the wheel brake modules 6, 10, 40, 44 and the axle controllers 28, 60, the brake system 2 corresponds to the brake system 2 shown in FIG. 1, although the wheel brake modules 6, 40 are not depicted in FIG. 2. The brake system 2 does not have signal line 82. Signal line 86 connects control unit 36 to control unit 68 bidirectionally. In this embodiment of the brake system 2, the braking input signal lines 76, 78 additionally serve as line 82, via which a signal from one axle controller 28, 60 can be transmitted to the other axle controller 60, 28. The brake pedal 72 thus acts as a router or hub.

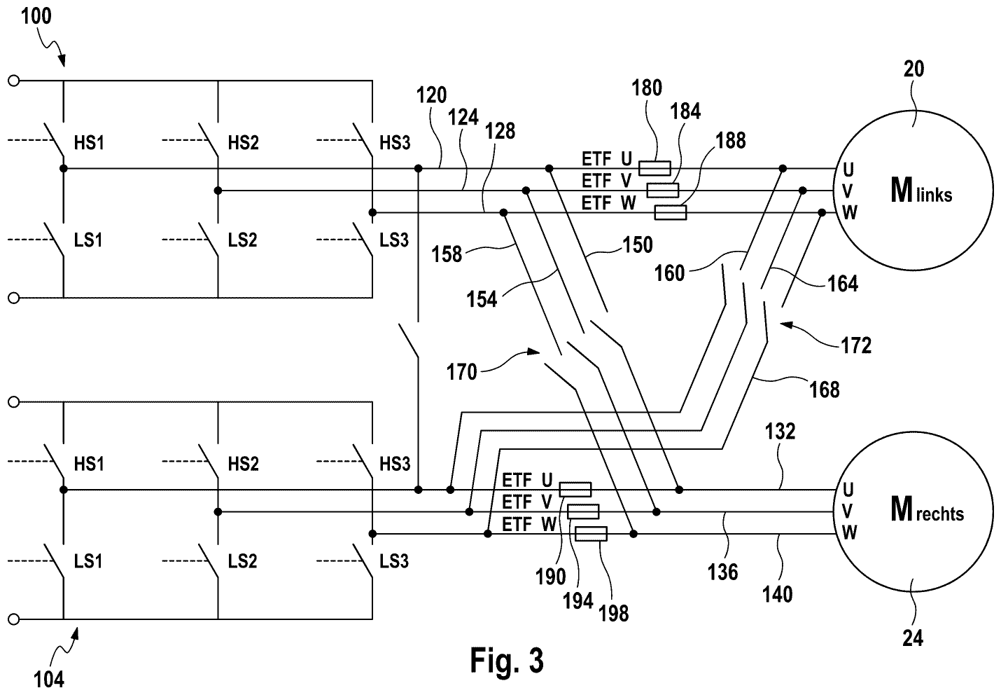

FIG. 3 shows a circuit in the axle controller 28 of the brake system shown in FIG. 1 and FIG. 2 with control units 32, 36 (not illustrated). The two control units 32, 36 are galvanically separated from one another. Control unit 32 has a B6 bridge 100, and control unit 36 has a B6 bridge 104. Three lines 120, 124, 128 lead from B6 bridge 100 to the motor of wheel brake 20. Three lines 132, 136, 140 lead from B6 bridge 104 to the motor of wheel brake 24. Lines 120 and 132, lines 124 and 136, and lines 128 and 140 are each connected to a connecting line 150, 154, 158 and to a connecting line 16, 164, 168. A cross switch 170 is inserted into the bundle of connecting lines 150, 154, 158. Another cross switch 172 is inserted into the bundle of connecting lines 160, 164, 168.

An ETF-type fuse 180, 184, 188 is inserted into each of lines 120, 124, 128. An ETF-type fuse 190, 194, 198 is inserted into each of lines 132, 136, 140. Connecting lines 150, 154, 158 branch off from lines 120, 124, 128 between bridge 100 and fuses 180, 184, 188. They enter lines 132, 136, 140 between fuses 190, 194, 198 and wheel brake 24. Connecting lines 160, 164, 168 branch off from lines 120, 124, 128 between fuses 180, 184, 188 and wheel brake 20. They enter lines 132, 136, 140 between bridge 104 and fuses 190, 194, 198. This arrangement allows the following functionality: the B6 bridge of the functioning control unit is used to fuse the ETFs or fuses 180-188 or 190-194 of the failed side. In this way, the faulty control unit 32, 36 can be separated electronically from the wheel brake 20, 24.

A cross switch is therefore required from each side behind the ETFs of the other side. The corresponding cross switch can also be used with any other type of motor fault (MPS, current sensor).

Lines 120-128 and 132-140 may be implemented as special conductor tracks on a circuit board and are embodied in such a way that they do not burn through in normal operation. In the event of a fault, however, they can be burnt through, as described above, thus enabling the bridge to be separated electronically or physically from the wheel brake 20, 24.

The brake system 2 described is of redundant construction with a high fault tolerance, with the result that the brake boosting does not have to be switched off directly if a brake control unit fails. In the brake system 2, as few as possible components are designed as unsprung masses, resulting in a smaller installation space at the wheel. For this purpose, the respective axle control unit or the respective axle controller 28, 60 is divided internally into two independent control units 32, 36 and 64, 68 or wheel control units with a separate power supply KI30 for each circuit board. The vibration of the control units 32, 36, 64, 68 is thereby reduced.

A diagonal split of the voltage supply can be provided in the brake system 2, and this is illustrated by way of example. A first supply voltage 210 supplies wheel module 6 (rear left-hand side) via supply lines 214, and supplies wheel module 44 (front right-hand side) via supply lines 218. A second supply voltage 220 supplies wheel module 10 (rear right-hand side) via supply lines 224, and supplies wheel module 40 (front left-hand side) via supply lines 228.

In summary, the disclosure provides a brake system 2, including:
a dry brake pedal 72 with a pedal sensor for detecting the driver input;
four electrically controllable wheel brake modules 6, 10, 40, 44, each comprising an electrically controllable wheel brake 20, 24, 54, 58,
   wherein
   two axle controllers 28, 60 are provided, with a first axle controller 28 is assigned two wheel brake modules 6, 10 and a second axle controller 60 is assigned two further wheel brake modules 40, 44, and wherein each of the two axle controllers 28, 60 is connected to the brake pedal 72 on a signal input side, and wherein each of the two axle controllers 28, 60 comprises two control units 32, 36; 64, 68, which each control one wheel brake 20, 24, 54, 58.

### LIST OF REFERENCE SIGNS

2 Brake system
6 Wheel brake module
10 Wheel brake module
14 Rear axle
20 Rear wheel brake
24 Rear wheel brake
28 Axle controller
32 Control unit
36 Control unit
40 Wheel brake module
44 Wheel brake module
50 Front wheel axle
54 Front wheel brake
58 Front wheel brake
60 Axle controller
64 Control unit
68 Control unit
72 Brake pedal
76 Braking input signal line
78 Braking input signal line
82 Signal line
86 Signal line
100 B6 bridge
104 B6 bridge
120 Line
124 Line
128 Line
132 Line
136 Line
140 Line
150 Connecting line
154 Connecting line
158 Connecting line
160 Connecting line
164 Connecting line
168 Connecting line
170 Cross switch
172 Cross switch
180 Fuse
184 Fuse
188 Fuse
190 Fuse
194 Fuse
198 Fuse
200 Signal line
204 Signal line
210 Supply voltage
214 Supply lines
218 Supply lines
220 Supply voltage
224 Supply lines
228 Supply lines

1-15. (canceled)

16. A brake system, comprising:
a dry brake pedal with a pedal sensor configured to detect driver input;
four electrically controllable wheel brake modules, each having an electrically controllable wheel brake;
a first axle controller assigned to two wheel brake modules and a second axle controller assigned to two other wheel brake modules, wherein each of the axle controllers is connected to the brake pedal on a signal input side, and wherein each of the axle controllers includes at least one control unit configured to control at least one wheel brake.

17. The brake system as claimed in claim 16, wherein the axle controller assigned to a front axle includes two control units, wherein each control unit controls at least one wheel.

18. The brake system as claimed in claim 16, wherein the axle controller assigned to the rear axle includes only one control unit and the axle controller assigned to the front axle includes two control units.

19. The brake system as claimed in claim 16, wherein, each axle controller includes only one control unit, and the control unit is configured to control two wheel brakes on an axle.

20. The brake system as claimed in claim 16, wherein the respective wheel brake module includes at least one of a brake actuator, a sensor, a valve, and a warning lamp.

21. The brake system as claimed in claim 20, wherein the respective axle controller includes two control units configured to ensure that, if one control unit in the axle controller fails, the other control unit in the same axle controller carries out the control of the brake actuator, the respective valve, the evaluation of the respective sensor signal, and/or the operation of the respective warning lamp.

22. The brake system as claimed in claim 16, wherein each axle controller include two control units connected to one another in such a way that, if one control unit fails, the other control unit takes over the control of the wheel brake in the wheel brake module which is assigned to the failed control unit.

23. The brake system as claimed in claim 16, wherein one control unit has a control connection to a B6 bridge for connection to another control unit, and wherein a cross switch is disposed in the respective control connection, and/or wherein fuses are disposed in the respective connection between the B6 bridge and a wheel brake.

24. The brake system as claimed in claim 16, further comprising at least one redundant bidirectional signal line connected between the first axle controller and the second axle controller, and wherein the axle controllers are each configured to enable at least one control unit of one axle controller (28) to take over the functionality of the at least one control unit of the other axle controller (60).

25. The brake system as claimed in claim 24, wherein the at least one signal line is routed via the brake pedal.

26. The brake system as claimed in claim 16, wherein the brake pedal is connected via a first signal line to the first axle controller and via a second signal line to the second axle controller.

27. The brake system as claimed in claim 16, wherein the at least one wheel brake is an electromechanical brake.

28. The brake system as claimed in claim 16, further comprising a pawl integrated into at least two wheel brake modules.

29. The brake system as claimed in claim 16, wherein the at least one control unit is implemented as two control units wherein the two control units are configured as two cores of a single processor.
